(19) United States
(12) Patent Application Publication
(10) Pub. No.: US 2009/0166022 A1
(43) Pub. Date: Jul. 2, 2009

(54) VEHICLE HEAT EXCHANGER AND METHOD FOR SELECTIVELY CONTROLLING ELEMENTS THEREOF

(76) Inventors: Sameer Desai, Lake Orion, MI (US); Sridhar Maddipatla, Auburn Hills, MI (US); Philip J. Davis, Dryden, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 11/967,242

(22) Filed: Dec. 30, 2007

(51) Int. Cl. G05D 23/00; F28D 1/00

(52) U.S. Cl. 165/279; 165/148

(57) ABSTRACT

A vehicle heat exchanger includes a first end tank, a second end tank opposite the first end tank, and a main core between and connecting the first and second end tanks. The main core includes a heat exchanger element including a plurality of tubes in fluid communication with the first and second end tanks. At least two control elements are operatively positioned in one or more housings that are operatively connected to the vehicle heat exchanger.

### BACKGROUND

The present disclosure relates generally to vehicle heat exchangers, and to a method for selectively controlling elements thereof.

Two goals for heat exchanger manufacturing often include forming a product that exhibits efficient transfer of heat, while maintaining a relatively simple manufacturing process. In the automotive industry, in particular, it has also become desirable to combine multiple functions into a single heat exchanger assembly. Combo-coolers and tri-coolers are examples of such assemblies, and each includes multiple, preferably coplanar coolers (non-limiting examples of which include oil coolers, condensers, radiators, etc.). In a combo- or tri-cooler, the tubes of each cooler are connected to the same pair of manifolds or end tanks. The coolers are often formed having a tube and fin structure, in part because of cost efficiency and ease of assembly.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals having a previously described function may or may not be described in connection with subsequent drawings in which they appear.

FIG. 1A is a semi-schematic perspective view of an embodiment of a vehicle heat exchanger with control element housings formed integrally with each end tank;

FIG. 1B is a schematic interior view of the embodiment of the vehicle heat exchanger of FIG. 1A;

FIG. 2 is a semi-schematic perspective view of an embodiment of a vehicle heat exchanger with a control element housing formed integrally with one end tank and having two control elements therein;

FIG. 3 is a semi-schematic cut-away perspective view of an embodiment of an end tank having a control element housing integrally formed therewith;

FIGS. 4A and 4B are semi-schematic cross-sectional cut-away views of an embodiment of the interior of an end tank having a control element housing integrally formed therewith, with a cap secured thereto (4A) and with the cap removed (4B);

FIG. 5 is a semi-schematic view of an end tank having an offset control element housing integrally formed therewith;

FIG. 6 is a semi-schematic perspective view of another embodiment of a vehicle heat exchanger with control element housings formed integrally with each end tank;

FIGS. 7A and 7B are semi-schematic cut-away perspective views of an embodiment of a vehicle heat exchanger with a control element housing attached to an end tank, where the control element housing has an additional connection part (7A) and a hose attached to the additional connection part (7B); and

FIG. 8 is a semi-schematic perspective view of another embodiment of a vehicle heat exchanger with control element housings attached to each end tank.

### DETAILED DESCRIPTION

Embodiments of the vehicle heat exchanger disclosed herein generally include two end tanks connected via a main core having various heat exchanger elements therein. Each end tank advantageously includes a control element; and as such, each vehicle heat exchanger includes multiple control elements. The multiple control elements are configured to separately control heat exchanger elements operatively connected thereto. By including a control element on each of the end tanks, it is believed that flexibility and variability in control over the cooling loop is increased. Furthermore, each of the control elements may advantageously be serviceable. Various embodiments of the vehicle heat exchanger are shown and discussed further hereinbelow in reference to the figures.

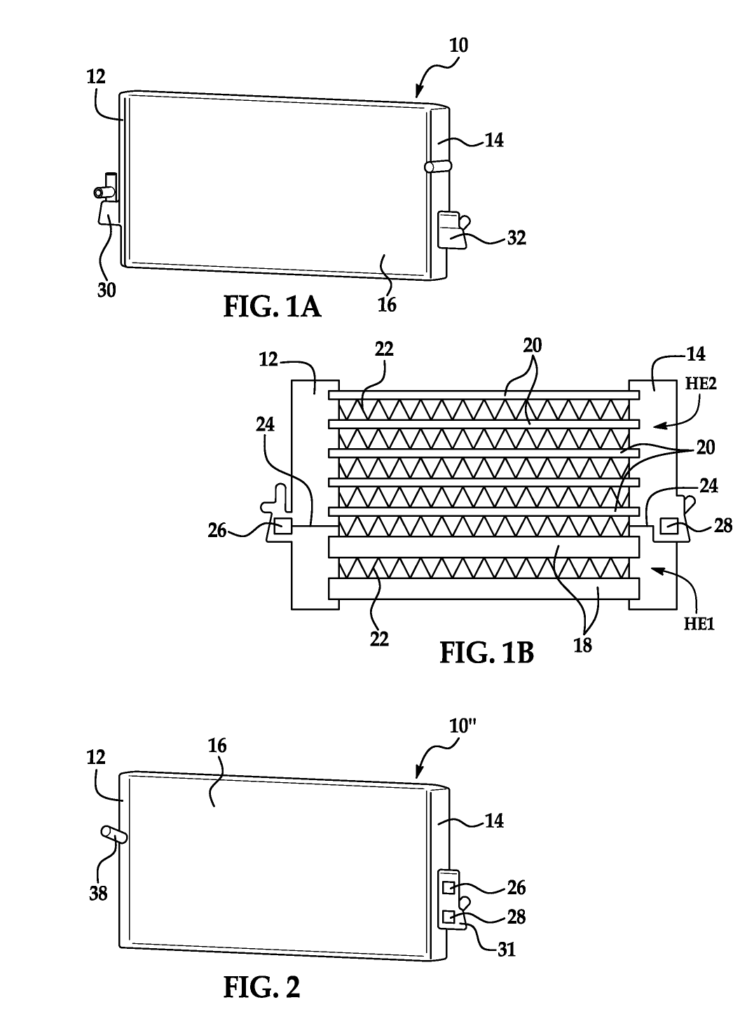

Referring now to FIGS. 1A and 1B, an embodiment of the vehicle heat exchanger 10 is depicted. As shown in FIG. 1A, the vehicle heat exchanger 10 includes a first end tank 12 and a second end tank 14 positioned opposite the first end tank 12. A main core 16 is operatively positioned between and connects the opposed end tanks 12, 14. The end tanks 12, 14 may be formed of polymeric material(s), and the main core 16 may be formed of aluminum alloys, copper, brass, or the like, or combinations thereof. Non-limiting examples of suitable polymeric materials include reinforced nylon based compounds, polyphenylene sulfone (PPS), polyphthalamide (PPA), other polypropylene based compounds, or the like, or combinations thereof. In some instances, the end tanks 12, 14 may also be formed of metallic materials.

As shown in FIG. 1B, the main core 16 includes multiple heat exchanger elements HE1, HE2. It is to be understood (as described further hereinbelow) that the heat exchangers HE1, HE2 may function as a single heat exchanger, depending, at least in part on the settings of the control elements 26, 28. Each heat exchanger element HE1, HE2 includes a plurality of tubes 18, 20. In the embodiment shown in FIG. 1A, the first heat exchanger element HE1 includes tubes 18, and the second heat exchanger HE2 includes tubes 20. A plurality of fins 22 is disposed between each of the tubes 18, 20. It is to be understood that at least one fluid (e.g., an automotive fluid) selectively flows throughout the tubes 18, 20, and the main core 16 conducts heat exchange for the one or more fluids.

The tubes 18, 20 may have different internal configurations for defining fluid passages therein. The tubes 18, 20 may also have different external configurations defining one or more outer peripheral surfaces. It is contemplated that the internal configurations, external configurations or combinations thereof may vary along the length of the tubes 18, 20. Furthermore, the internal configuration of the tubes 18, 20 may be the same or different from the external configuration. Non-limiting examples of internal and external configurations includes grooves, ridges, bosses, or other like structures integrated along some or all of the tube 18, 20 length for assisting in heat transfer and/or for adding strength to the structure.

The internal configurations may also generate turbulence within the fluid, or otherwise control the nature of the flow of fluid therethrough. In other embodiments, the internal configuration of the tubes 18, 20 may be smooth, planar, grooved, ridged, contoured (e.g., including several patterned ridges), ribbed (i.e., including several protrusions), dimpled (e.g., including several depressions) or the like.

In still other embodiments, the tubes 18, 20 may include one or more internal inserts, which are fabricated separately from the tubes 18, 20 and are assembled therein. It is contemplated that inserts may be formed in a variety of configurations and shapes for insertion into the fluid passages or portions of fluid passages. As a non-limiting example, the inserts may be members (e.g., straight or contoured members) with complex or simple configurations. Alternatively, inserts may be coils, springs or the like.

The fluid passages of the tubes 18, 20 may have any suitable configuration, including square, rectangular, circular, elliptical, irregular, or the like. The fluid passages of the tubes 18, 20 may also include one or more partitions, fins or the like.

Formation of tubes 18, 20 may be accomplished using several different techniques. As non-limiting examples, the tubes 18, 20 may be drawn, rolled, cast or otherwise formed. Additionally, the tubes 18, 20 may be formed of a variety of materials including plastics, metals, carbon, graphite, other formable materials or the like. More specific non-limiting examples of suitable tube 18, 20 materials include a metal selected from copper, copper alloys, low carbon steel, stainless steel, aluminum alloys, titanium alloys, magnesium alloys, or the like, or combinations thereof. In a non-limiting example, the tubes are formed of aluminum, or copper-based alloys. The tubes 18, 20 may also be coated or otherwise surface treated over some or all of its length for locally varying the desired property. Still further, it is to be understood that the tubes 18, 20 may be dimpled or otherwise configured with other features which generate increased heat transfer through turbulence.

The tubes 18, 20 may also have the same or different hydraulic diameters. In some instances, some of the tubes 18, 20 within the same heat exchanger element HE1, HE2 may have different hydraulic diameters. The hydraulic diameter is generally configured to obtain maximum effectiveness of the exchanger element HE1, HE2. As used herein, the hydraulic diameter (D_{H}) is determined according to the following equation:

D_{H}=4A_{P}/P_{w}

wherein

Aₚ=wetted cross-sectional area of the passageway of a tube; and

P_{w}=wetted perimeter of the tube.

Each of the variables (P_{w} and Aₚ) for the hydraulic diameter (D_{H}) are determinable for a tube 18, 20 according to standard geometric and engineering principles and will depend, at least in part, upon the configuration of a particular tube 18, 20 and the aforementioned variables for that tube 18, 20 (i.e., the number of partitions, the number of portions, the size of the portions, the size of the fluid passages, or combination thereof).

Heat transfer and pressure drop for a fluid flowing through the tubes 18, 20 can be determined for a range of hydraulic diameters using sensors such as pressure gauges, temperature sensors or the like.

If desired, baffles 24 may be included to partition the end tanks 12, 14. In some instances, the baffles 24 separate the first and second heat exchangers HE1, HE2. It is to be understood that the baffles 24 divide the tubes 18, 20 into separate zones, and through control elements 26, 28 (discussed further hereinbelow), one may operate the zones as a single heat exchanger or as multiple heat exchangers HE1, HE2 (as shown in FIG. 1B). In the embodiment shown in FIG. 1B, the control elements 26, 28 may be used to control the fluid flow through tubes 18 and/or through tubes 20. Two controllers 26, 28 advantageously provide more flexibility and enable more cooling loop options than a single control element. As such, control elements 26 and 28 may be operated such that the amount of flow through the tubes 18, 20 is achieved based on the desired control loop logic.

While not shown in FIG. 1A or 1B, one or both of the end tanks 12, 14 includes at least one connector for fluid communication. It is to be understood that the tank(s) 12, 14 may include additional inlets and outlets, depending, at least in part, on the requirements for the loop. Baffles 24 may also be included to separate those tubes 18, 20 connected to the inlet from those tubes 18, 20 connected to the outlet.

As shown in FIGS. 1A and 1B, each of the end tanks 12, 14 may include a respective control element housing 30, 32 formed integrally therewith. The control element housing 30, 32 is formed at a desirable position on each of the respective end tanks 12, 14 such that the respective control elements 26, 28 are in a position to operatively control fluid flow through the tubes 18, 20.

FIG. 2 depicts another embodiment of the vehicle heat exchanger 10″. Similar to the embodiment shown in FIG. 1A, the vehicle heat exchanger 10″ includes the first end tank 12 and the second end tank 14 positioned opposite the first end tank 12. The main core 16 is operatively positioned between and connects the opposed end tanks 12, 14. In this embodiment, a single housing 31 is formed integrally with one end tank 14 and is configured to operatively contain two or more control elements 26, 28 (described further hereinbelow). It is to be understood that either of the end tanks 12, 14 may contain such a housing 31; and that the housing 31 may be configured to hold as many control elements 26, 28 as is desirable.

In still another embodiment (not shown in the Figures), each control element 26, 28 is operatively positioned in a respective housing 30, 32, and each housing 30, 32 is integrally formed with and/or is attached to one of the end tanks 12, 14.

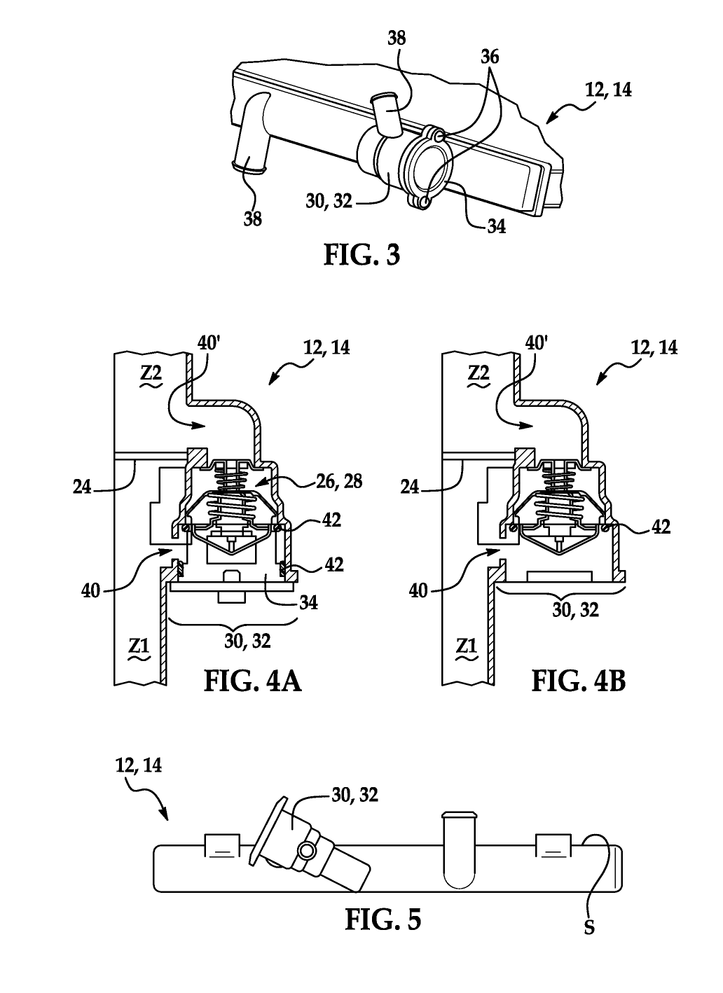

FIG. 3 depicts an end tank 12, 14 having the control element housing 30, 32 formed integrally therewith. It is to be understood that when the control element housing 30, 32 is formed integrally with the end tank 12, 14, the control element housing 30, 32 is formed of the same material as the end tank 12, 14.

As shown in FIG. 3, the control element housing 30, 32 may be formed to removably receive a cap 34. Screws 36, or any other suitable securing means (e.g., bolts, latches, clips, or the like, or combinations thereof may be used to removably secure the cap 34 to the housing 30, 32. It is to be understood that the cap 34 may be removed such that the control element 26, 28 (not shown here) contained within the housing 30, 32 may be serviced. It is to be understood that if control element 26, 28 serviceability is not desired, the cap 34 may be permanently secured to the housing 30, 32.

In some instances, the control elements 26, 28 may be integrated with the cap 34, such that when the cap 34 is removed, so is the control element 26, 28.

FIG. 3 also depicts multiple fluid connections 38, which may be used to direct fluids to and from the heat exchangers HE1, HE2 in fluid communication with the particular end tank 12, 14. As previously mentioned, it is to be understood that while two zones or heat exchangers HE1, HE2 are shown and referenced, it is to be understood that the control elements 26, 28 may be configured such that the tubes 18, 20 function as a single heat exchanger. Furthermore, it is to be understood that additional zones may be formed, and that additional control elements 26, 28 may be included as desired.

Referring now to FIGS. 4A and 4B, cross-sectional views of an embodiment of the interior of the control element housing 30, 32 and the end tank 12, 14 to which it is integrally formed are depicted. FIG. 4A illustrates the housing 30, 32 with the cap 34 in place, and FIG. 4B illustrates the housing 30, 32 with the cap 34 removed (rendering the control element 26, 28 serviceable).

Operatively disposed in the housing 30, 32 is the control element 26, 28. Non-limiting examples of suitable control elements 26, 28 include pressure actuated devices, temperature activated devices (e.g., a thermostat), and combinations thereof. Another non-limiting example of a suitable control element 26, 28 is an electromechanical device actuated via external signals. Some non-limiting examples of suitable electromechanical devices include solenoid activated valves, electric motor driven valves, memory metal actuated valves, or the like, or combinations thereof. As such, some embodiments of the control element 26, 28 may include an additional component (e.g., an external signaling device) that is located remotely from the first or second end tank 12, 14. It is to be understood that whether the control elements 26, 28 are self-actuated or externally actuated, they are used to regulate the flow of fluid through different areas of the main core 16 to correspond to a predetermined fluid loop.

Generally, the control element 26, 28 sits on a mating flange in the housing 32, 34, and is clamped into place by a cover or cap held in by fasteners (examples of which are mentioned above). In addition to the cap 34, other seals 42 may be used to secure the control element 26, 28 in the housing 32, 34. Non-limiting examples of such seals 42 include those formed of elastomeric materials.

Also shown in FIGS. 4A and 4B is a baffle 24. In this embodiment, the baffle 24 is used to separate two openings 40, 40′ in the end tank 12, 14. The separation of the openings 40, 40′ forms two zones Z1, Z2 that are controllable via the single control element 26, 28. It is to be understood that each of the zones Z1, Z2 includes a plurality of tubes 18, 20 (not shown in FIGS. 4A and 4B), where one or more fluids exchange heat at the same or different rates.

FIG. 5 depicts another embodiment of the end tank 12, 14 having the control element housing 30, 32 formed integrally therewith. In this embodiment, the housing 30, 32 is formed at an angle (other than 90°) relative to a surface S of the end tank 12, 14. It is to be understood that the housing 30, 32 may be formed at any desirable angle with respect to the surface S.

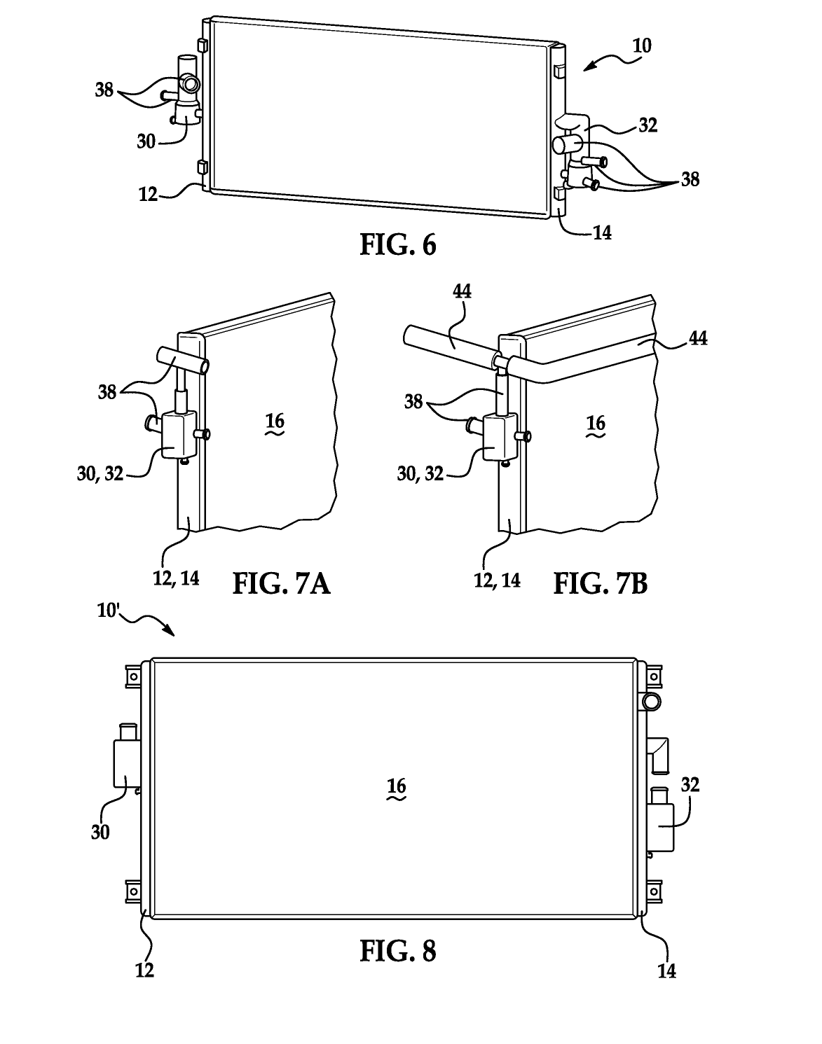

Referring now to FIG. 6, another embodiment of the vehicle heat exchanger 10 is depicted. Similar to the embodiment shown in FIG. 1A, the vehicle heat exchanger 10 includes two opposed end tanks 12, 14 attached to the main core 16, and respective control element housings 30, 32 formed integrally with each of the end tanks 12, 14. The housings 30, 32 in this embodiment include multiple fluid connections 38. Such fluid connections 38 may be operatively connected to, for example, a radiator hose, a de-gas bottle, or other like fluid circuits, e.g., transmission, power steering system or engine oil circuits, charge air coolers, exhaust air coolers, and/or the like.

FIGS. 7A and 7B also depict the respective control element housings 30, 32 having multiple fluid connections 38. Hoses 44, which may be part of a cooling loop, may be attached to the multiple fluid connections 38 for transporting fluid therein.

Referring now to FIG. 8, another embodiment of the vehicle heat exchanger 10′ is depicted. In this embodiment, the control element housings 30, 32 are not formed integrally with the end tanks 12, 14. Rather, the control element housings 30, 32 are formed separately from the end tanks 12, 14 and are then attached thereto, e.g., via fasteners such as bolts, clamps, clips, and/or the like, and generally with a gasket for improved sealing. The non-integrally formed control element housings 30, 32 are attached such that the control element 26, 28 positioned therein is able to selectively control fluid flow to the tubes 18, 20 operatively connected thereto. Generally, the non-integrally formed control element housings 30, 32 are formed as a single piece, and are configured to fit a surface shape of the end tank 12, 14 to which it is attached.

In any of the embodiments disclosed herein, it is to be understood that more than one control element 26, 28 may be operatively connected to an end tank 12, 14. The end tank 12, 14 may include additional housings 30, 32 formed integrally therewith or attached thereto. Such additional control elements 26, 28 may be used to control additional heat exchanger elements HE1, HE2 operatively positioned in the main core 16.

Furthermore, in any of the embodiments disclosed herein, the first and second ends tanks 12, 14 may be part of a low temperature loop. In vehicle cooling loops, the engine cooling loop is often considered a high temperature loop, and the main engine is part of the loop. Generally, a single control element in an integrally formed housing 30, 31, 32 is not suitable when the heat exchanger is part of a high temperature loop, or is part of an engine cooling loop. However, when multiple control elements 26, 28 are used as taught in the present disclosure, the heat exchanger may advantageously be used in any cooling loop and may be housed in integrally formed or separately attached housings 30, 31, 32.

Low temperature loops have been implemented to cool additional areas of vehicle. In some instances, low temperature loops provide fluids to different areas of the vehicle (e.g., charge air cooler, transmission oil cooler, engine oil cooler, fuel cooler, exhaust gas cooler, etc.) at a lower temperature when compared to the main engine loop or high temperature loop. It is to be understood that the heat exchanger 10, 10′, 10″ disclosed herein and cooling loops may be configured such that a high temperature loop and a low temperature loop may be achieved in one heat exchanger 10, 10′, 10″, or such that a high temperature loop and a low temperature loop may be achieved through multiple heat exchangers 10, 10′, 10″. When an independent low temperature loop is used, the engine is not part of the loop, and cooling fluid is managed within a completely separate loop that is not part of the engine cooling loop. In this instance, the heat exchanger 10, 10′, 10″ (or low temperature radiator) does not support cooling of the engine.

In one non-limiting example, the vehicle heat exchanger 10, 10′ disclosed herein may be integrated into a low temperature cooling loop. In cold conditions, the control elements 26, 28 may be closed, allowing fluid to by-pass the heat exchanger elements HE1, HE2, and flow directly to an exhaust gas cooler, a transmission oil cooler, a fuel cooler, and a charge air cooler. In warm conditions, one of the control elements 26, 28 may be opened to allow approximately ⅓ of the fluid to flow through one of the heat exchanger elements HE1, HE2 and then into the fuel cooler and the charge air cooler. The other control element 28, 26 remains closed such that the other ⅔ of the fluid by-passes the other heat exchanger element HE2, HE1 and is directed to the exhaust air cooler and the transmission oil cooler. In hot conditions, both of the control elements 26, 28 may be opened to allow all of the fluid to flow through the heat exchanger elements HE1, HE2. Generally, about ⅓ of the fluid flows through one of the heat exchanger elements HE1, HE2 and into the fuel cooler and the charge air cooler, while about ⅔ of the fluid flows through the other of the heat exchanger elements HE2, HE1 and into the exhaust air cooler and the transmission oil cooler. It is to be understood that the vehicle engine may or may not be a part of this cooling loop.

Embodiments of the vehicle heat exchanger 10, 10′, 10″ disclosed herein include, but are not limited to the following advantages. It is believed that the cost of manufacturing such a device is reduced, in part because the housing 30, 31, 32 may be integrally formed with the end tank(s) 12, 14. It is further believed that the lifetime of the control elements 26, 28 may be advantageously increased, in part because the housing 30, 31, 32 creates an efficient seal for the control elements 26, 28, thereby reducing the exposure of the elements 26, 28 to fluids. Furthermore, the configuration of the housing 30, 31, 32 for the serviceability of the control elements 26, 28 enables relatively easy replacement of such elements 26, 28.

While several embodiments have been described in detail, it will be apparent to those skilled in the art that the disclosed embodiments may be modified. Therefore, the foregoing description is to be considered exemplary rather than limiting.

What is claimed is:

1. A vehicle heat exchanger, comprising:
a first end tank;
a second end tank opposite the first end tank;
a main core between and connecting the first and second end tanks, the main core including a heat exchanger element including a plurality of tubes in fluid communication with the first and second end tanks; and
at least two control elements operatively positioned in one or more housings that are operatively connected to the vehicle heat exchanger.

2. The vehicle heat exchanger as defined in claim 1, further comprising an additional control element operatively connected to at least one of the first end tank or the second end tank.

3. The vehicle heat exchanger as defined in claim 1 wherein at least one of the at least two control elements is selected from pressure actuated devices, temperature activated devices, and combinations thereof.

4. The vehicle heat exchanger as defined in claim 1 wherein at least one of the at least two control elements is an electromechanical device actuated via external signals.

5. The vehicle heat exchanger as defined in claim 1 wherein at least one of the at least two control elements includes an additional component that is located remotely from the one or more housings.

6. The vehicle heat exchanger as defined in claim 1, further comprising a baffle configured to separate two openings in at least one of the first end tank or the second end tank, thereby creating two zones controllable via a first of the at least two control elements, a second of the at least two control elements, or combinations thereof.

7. The vehicle heat exchanger as defined in claim 6 wherein a first of the two zones includes at least some of the plurality of tubes having a first hydraulic diameter, and wherein a second of the two zones includes at least some other of the plurality of tubes having a second hydraulic diameter different from the first hydraulic diameter.

8. The vehicle heat exchanger as defined in claim 1 wherein a vehicle engine is part of a cooling loop of the heat exchanger element.

9. The vehicle heat exchanger as defined in claim 1 wherein the at least two control elements are serviceable.

10. The vehicle heat exchanger as defined in claim 1 wherein the one or more housings are formed integrally with the first end tank or the second end tank.

11. The vehicle heat exchanger as defined in claim 1 wherein the one or more housings are formed integrally with the vehicle heat exchanger, are attached to the vehicle heat exchanger, or combinations thereof.

12. A method for selectively controlling at least two heat exchanger elements in a vehicle heat exchanger, the method comprising:
operatively connecting each of the at least two heat exchanger elements to a first end tank and a second end tank;
operatively connecting a first control element to the first end tank or the second end tank such that it controls one or both of the at least two heat exchanger elements; and
operatively connecting a second control element to the first end tank or the second end tank such that it controls one or both of the at least two heat exchanger elements.

13. The method as defined in claim 12, further comprising positioning at least one of the first control element or the second control element in a housing that is formed integrally with the first end tank or the second end tank, respectively.

14. The method as defined in claim 12, further comprising positioning at least one of the first control element or the second control element in a housing that is operatively attached to the first end tank or the second end tank, respectively.

15. The method as defined in claim 12, further comprising positioning each of the first and second control elements in a housing formed integrally with the first end tank or the second end tank.

16. The method as defined in claim 12, further comprising operatively connecting an additional control element to at least one of the first end tank or the second end tank.

17. The method as defined in claim 12 wherein at least one of the first or second control elements is selected from pressure actuated devices, temperature activated devices, electromechanical devices actuated via external signals, and combinations thereof.

18. The method as defined in claim 12, further comprising incorporating a baffle in at least one of the first end tank or the second end tank to separate two openings therein, thereby creating two zones controllable via the first control element, the second control element, or combinations thereof.

19. The method as defined in claim 18 wherein a first of the two zones includes a first plurality of tubes having a first hydraulic diameter, and wherein a second of the two zones includes a second plurality of tubes having a second hydraulic diameter different from the first hydraulic diameter.

20. The method as defined in claim 12 wherein the first heat exchanger element includes a plurality of first tubes in fluid communication with the first and second end tanks, and wherein the second heat exchanger element includes a plurality of second tubes in fluid communication with the first and second end tanks, and wherein the method further comprises disposing a plurality of fins between each of the tubes.

21. The method as defined in claim 12, further comprising servicing at least one of the first control element or the second control element.

22. A vehicle heat exchanger, comprising:
a first end tank;
a second end tank opposite the first end tank; and
a main core between and connecting the first and second end tanks, the main core including:
a first heat exchanger element including a plurality of first tubes in fluid communication with the first and second end tanks;
a second heat exchanger element including a plurality of second tubes in fluid communication with the first and second end tanks;
a first control element operatively connected to the first end tank and configured to control the first heat exchanger element, the second heat exchanger element, or a combination of the first and second heat exchanger elements;
a second control element operatively connected to the second end tank and configured to control the second heat exchanger element, the first heat exchanger element, or a combination of the first and second heat exchanger elements; and
a plurality of fins disposed between each of the tubes.

23. The vehicle heat exchanger as defined in claim 22 wherein at least one of the first control element or the second control element is positioned in a housing that is formed integrally with the first end tank or the second end tank, respectively.

24. The vehicle heat exchanger as defined in claim 22 wherein at least one of the first control element or the second control element is positioned in a housing that is operatively attached to the first end tank or the second end tank, respectively.

25. A vehicle heat exchanger, comprising:
a first end tank;
a second end tank opposite the first end tank, the first and second end tanks being part of a low temperature cooling loop;
a main core between and connecting the first and second end tanks, the main core including a heat exchanger element including a plurality of tubes in fluid communication with the first and second end tanks; and
at least one control element positioned in a housing that is operatively connected to the first end tank or the second end tank of the low temperature cooling loop.

26. The vehicle heat exchanger as defined in claim 25 wherein the housing is formed integrally with the vehicle heat exchanger, is attached to the vehicle heat exchanger, or combinations thereof.
